(19) United States
(12) Patent Application Publication
(10) Pub. No.: US 2020/0288625 A1
(43) Pub. Date: Sep. 17, 2020

(54) AGRICULTURAL UTILITY VEHICLE

(71) Applicant: ZF Friedrichshafen AG, Friedrichshafen (DE)

(72) Inventors: Hans Pilzweger, Neuhaus am Inn (DE); Daniel Nachbaur, Ravensburg (DE)

(21) Appl. No.: 16/649,665

(22) PCT Filed: Aug. 29, 2018
(86) PCT No.: PCT/EP2018/073202

§ 371 Date: Mar. 23, 2020

(30) Foreign Application Priority Data
Sep. 29, 2017 (DE) 10 2017 217 391.2

(51) Int. Cl. A01B 79/00; A01B 69/04

(52) U.S. Cl. CPC A01B 79/005; G05D 1/0246; A01B 69/008

(57) ABSTRACT

An agricultural work vehicle. The agricultural work vehicle includes a track guidance system. The track guidance system includes an optical image-capture device arranged on the work vehicle and being configured to record reference objects located along a track driven by the agricultural work vehicle. The track guidance system further includes an image processing system configured to differentiate the recorded reference objects, and a control device configured to evaluate the reference object and prespecify a track based, at least in part, on the evaluation of the reference objects.

### CROSS REFERENCE TO RELATED APPLICATIONS

This application is a U.S. National Stage Application under 35 U.S.C. § 371 of International Application No. PCT/EP2018/073202 filed on Aug. 29, 2018, and claims benefit to German Patent Application No. DE 10 2017 217 391.2 filed on Sep. 29, 2017. The International Application was published in German on Apr. 4, 2019 as WO 2019/063232 A1 under PCT Article 21(2).

### FIELD

The invention relates to an agricultural work vehicle having a track guidance system, comprising at least one optical image-capture device disposed on the work vehicle, and an image processing system. The invention also relates to a method for specifying a track of an agricultural work vehicle.

### BACKGROUND

In the case of agricultural machines, there has been a recent development to control and steer said machines with the aid of automatic position-determination devices. For example, satellite-based position-determination devices, so-called GPS systems, are used in order to automatically control processing parameters of the agricultural machine in question, such as, for example, the quantity of seed applied, doing so with the aid of cartographically stored field information such as soil condition, moisture, etc., and the actual position determined in each case. Furthermore, attempts are also already being made to steer the agricultural machine automatically by means of GPS. However, it has hitherto been difficult to be able to drive along the target route precisely enough using GPS. In order to increase the accuracy of GPS control, it is further known to provide correction signals to improve the accuracy of position determination. The correction signal is either provided by a stationary reference station or, as a rule, by a mobile GPS station which is set up at the field edge. In both cases, high usage fees arise. In addition, the additional time investment needed for the mobile GPS station to be set up and taken down is disadvantageous.

An agricultural machine having an optical image-capture device, which captures an image of a current route of the agricultural machine, is known from DE 103 28 395 A1. This current image of the environment ahead of the agricultural machine in the direction of travel is compared with stored image data of the target route of the agricultural machine. Control commands for steering the agricultural machine are automatically provided using this image comparison. The fact that the track guidance system disclosed in DE 103 28 395 A1 forces the vehicle onto a predefined route in a manner analogous to GPS-based systems means that this target route must first be established beforehand. On the other hand, this predefined route can then deviate considerably from the real conditions if, due to growth, driving over the area in an optimal manner to spare the plants would require driving over the area in a manner deviating from the predefined route.

### SUMMARY

In an embodiment, the present invention provides an agricultural work vehicle. The agricultural work vehicle includes a track guidance system. The track guidance system includes an optical image-capture device arranged on the work vehicle and being configured to record reference objects located along a track driven by the agricultural work vehicle. The track guidance system further includes an image processing system configured to differentiate the recorded reference objects, and a control device configured to evaluate the reference object and prespecify a track based, at least in part, on the evaluation of the reference objects.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 provides a schematic representation of an agricultural work vehicle;

FIG. 2 provides a schematic representation of cropland to be cultivated;

FIG. 3 provides a schematic representation of a tractor with a mounted sowing machine in a plan view;

FIG. 4 provides a rear view of a tractor with a mounted plow; and

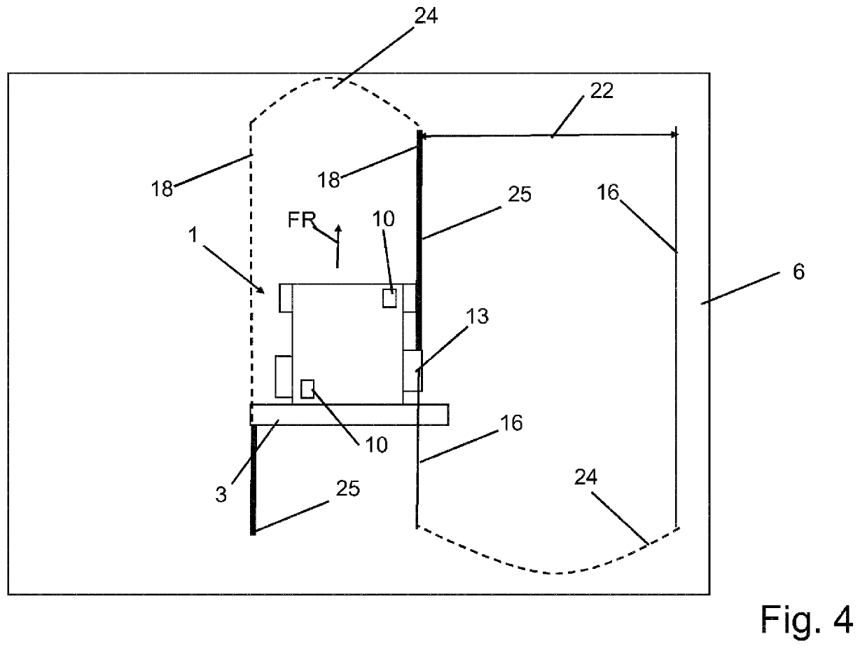

FIG. 5 provides a schematic representation of the visualization of a track and of a prespecified track on a display device.

### DETAILED DESCRIPTION

The present invention provides an agricultural work machine and further provides a method for specifying a track of an agricultural work vehicle, both of which avoid certain disadvantages of the prior art. In particular, the present invention provides for a simplified, more flexible track guidance.

The invention relates to an agricultural work vehicle comprising a track guidance system, wherein the track guidance system comprises at least one image-capture device disposed on the work vehicle and an image processing system. The track guidance system is intended to assist an operator of the agricultural work vehicle in finding the correct entry point onto a new track and in keeping to the track.

In the context of the invention, the agricultural work vehicle may be a tractor or a tractor with an attachment arranged, in particular at the rear, or a self-propelled harvesting machine with an attachment arranged thereon. The attachment can, for example, be a soil-treatment device, a sprayer for dispensing fertilizer or crop protection agents, or a sowing machine. The front attachment may take the form of, for example, a grain header, a row-processing corn header, or as a sunflower cutter. The rear attachments and front attachments have in common the fact that, when driving over a field to be worked, specific distances to a previous track are to be observed which derive from the type of rear attachment or front attachment.

The invention provides for reference objects located along a track driven along by the work vehicle to be optically captured by the at least one image-capture device and to be differentiated by means of the image processing system and further provides for a track to be prespecified by means of an evaluation of the reference objects performed by a control device. The reference objects are, on the one hand, previously existing punctiform or linear reference objects, such as individual plants, plant rows, plant ridges or plant walls or the like, but also already existing tracks. On the other hand, the reference objects are reference objects generated during passage along a track, such as an edge of a crop, a furrow produced during soil cultivation, or a line produced by a track marker of a tillage device. The recording of images for recognizing the reference objects during passage along a track has the advantage that the current situation in the field to be driven over is always taken into account when prespecifying the new track.

In contrast, in the case of the track guidance system in DE 103 28 395 A1, this is dependent on how current the image comparison material of the target route is on which track guidance is based. According to the invention, track guidance can always be based on the current situation in the field. Compared to a GPS-based track guidance system, no additional correction signal is required due to the higher level of accuracy of track guidance achievable by optical recognition and evaluation.

Preferably, at least one image-capture device is arranged on the agricultural work vehicle, whose field of vision is substantially directed in the direction of travel. In this case, the field of vision can be adjusted both in a vertical and a horizontal direction in order to be adapted to the working width of a rear attachment or front attachment. It is also conceivable for a further image-capture device to be arranged in the rear part of the work vehicle in order to detect the tracks which have been created or the reference objects generated.

According to one embodiment of the invention, the track guidance system comprises a display device on which the track prespecified by the control device can be visualized. In this way, the operator of the work vehicle is provided with an orientational aid which makes it easier for the operator to find the correct entry point onto the new prespecified track and also to keep to it. The new prespecified track can be projected in the form of auxiliary lines onto at least one of the images, which had been evaluated by the image-capture system in order to prespecify the new track. Preferably, the images recorded when driving along the previous track can be displayed sequentially on the display device and the auxiliary lines representing the prespecified track can be superimposed thereon.

Furthermore, an entry point onto the prespecified track can be visualized on the display device. This makes it easier to enter onto the new track after a headland.

Furthermore, deviations of the work vehicle from the prespecified track can be visualized on the display device. As a result, necessary corrections can be made more precisely and quickly when the operating vehicle is manually steered by the operator. For this purpose, the prespecified track can be represented as a line in a first color, while a deviation therefrom is represented by a line in a second color. In addition, instructions, which visualize steering corrections necessary for keeping to the prespecified track, can be superimposed on the display device.

In a further development of the invention, it is provided that the control device be set up for autonomous steering of the work vehicle with the aid of the prespecified track. As a result, the operator is relieved of the task of keeping to the track and can concentrate on the performance and monitoring of the various work processes. For this purpose, steering hydraulics of the agricultural work vehicle can be controlled by the control device.

In particular, the track guidance system can be set up to recognize and/or count reference objects present in the form of a row. Counting reference objects in the form of crop rows, in order to determine the track at the correct distance from the previous track, is of particular importance for the precise application of fertilizer or crop protection agents. Overdosages due to overlaps caused by excessively small distances between adjacent tracks can thus be avoided.

Furthermore, the tracking system may be configured to define a distance between a track driven by the work vehicle and a reference line generated during it. Thus, for example, during sowing a line is drawn in the soil by a sowing machine using a so-called track marker. This auxiliary line serves to define the correct distance from the previous track. For this purpose, the operator must then drive the next track with his tire on this auxiliary line in order to be able to maintain the correct distance from the previous track.

In a further development of the invention, it is provided that a working width of a rear attachment mounted on the work vehicle can be supplied to the track guidance system. The information about the width of the rear attachment can be supplied by manual input on the part of the operator via an input interface of the control device. An automatic recognition of the rear attachment by the connection to a bus system of the work vehicle or the reading out of an RFID beacon or a QR code, which include inter alia information on the working width of the rear attachment, is also conceivable.

In a preferred embodiment, the at least one image-capture device takes the form of a 3D camera from an angle-offset two-camera system or a 2D camera with run-time measurement.

Furthermore, the task set at the outset is solved by a method for specifying a track of an agricultural work vehicle, wherein reference objects located along a track driven by the work vehicle are optically captured by means of at least one optical image-capture device, that the optically captured reference objects are differentiated by an image-capture system, and that the track is prespecified using an evaluation of the reference objects performed by a control device. The method makes it possible to distinguish between the different reference objects which are supplied to the evaluation by the control device in order to determine distances, contour and/or the number of rows of the respective reference objects by means of which the new track is prespecified.

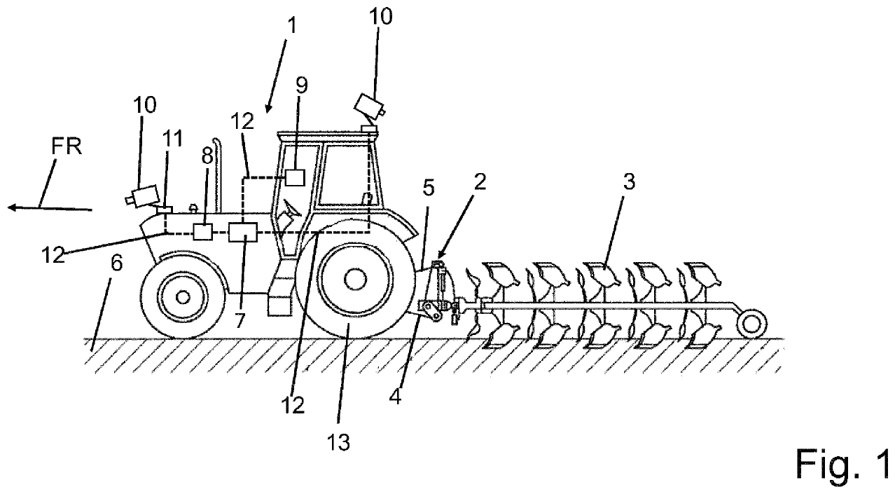

FIG. 1 shows a schematic representation of an agricultural work vehicle, which in the present case is embodied as a tractor 1. This tractor 1 carries on a rear lifting mechanism 2 an attachment in the form of a plow 3, the lifting mechanism 2—only partially discernible here—being designed in the form of a three-point hydraulic system, which connects the plow 3 to the tractor 1 by two lower links 4 and an upper link 5. The lower links 4 and the upper link 5 located at the same height are adjustable in position by lift cylinders—not shown further here—so that a working height of the plow 3 is adjusted relative to a cropland surface 6.

The tractor 1 comprises a control device 7, which is connected to an image processing system 8 and a display device 9 arranged in the cabin of the tractor 1 by means of a bus system 12 shown in broken lines. The bus system 12 also connects at least one image-capture device 10 arranged at the front of the tractor 1 to the image processing system 8. In the exemplary embodiment shown, a further image-capture device 10 is arranged on the rear part of the tractor. The field of vision of the image-capture device 10 arranged at the front is directed substantially in the direction of travel FR. The image-capture device 10 can be adjusted by means of an actuator 11, not only with respect to the angle of inclination relative to the cropland surface 6 but also by a rotational angle about a vertical axis of rotation. The image processing system 8 as well as the front and rear image-capture devices 10 are part of a track guidance system of the tractor 1.

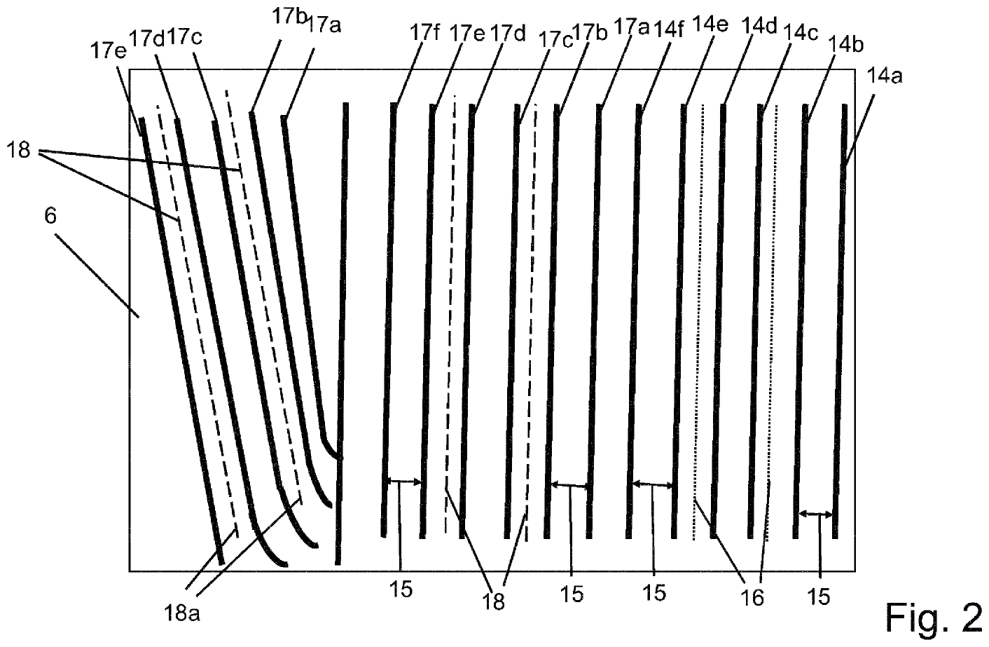

FIG. 2 shows a schematic representation of a field or cropland 6 to be cultivated. Reference signs 14a through 14f and 17a through 17f denote planted rows. The rows 14a through 14f and 17a through 17f each have prespecified row interspaces 15 which are set during the sowing of seeds. Reference sign 16 denotes a current track which is driven along by the tractor 1. Reference sign 18 denotes a prespecified track, which the tractor 1 should ideally drive along after passing a headland so that required row interspaces are observed. This is necessary if the tractor 1 is equipped with an attachment in the form of a hose, in order, for example, to dispense crop protection agents or fertilizers. In the application of crop protection agents or fertilizers, precisely maintaining the row interspaces 15 is of particular importance in order to prevent an overdose or an undersupply. As further indicated in FIG. 2, the rows 17a through 17f may take a different course to the preceding rows 14a through 14f This requires that a new entry point 18a be found, which can be effected by counting the rows 17a to 17f within the context of image evaluation.

In order to assist an operator of the tractor 1 in cultivating the cropland 6, it is provided that the front image-capture device 10 records one or more images of the cropland 6 seen in the direction of travel FR in order to determine the number of rows 14a through 14f as well as their respective row interspaces 15 by means of the image processing system 8. In conjunction with the working width of the rear attachment, the control device 7 prespecifies the next track 18. Information about the working width of the attachment can be provided by manual input on the part of the operator. Alternatively, automated recognition of the working width by the control device is conceivable. This can be done by connecting the attachment to a bus system of the work vehicle or by reading out an RFID beacon or a QR code on the attachment, which include inter alia information on the working width of the attachment. In addition to specifying the row interspaces 15, it is also possible to specify the number of rows 14a to 14f which fall within the working width of the attachment.

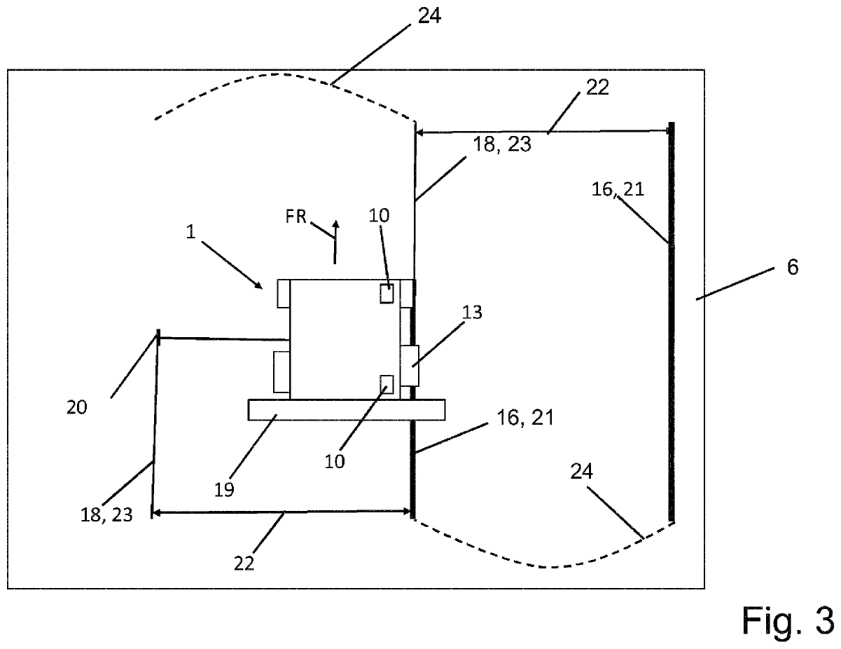

FIG. 3 shows a schematic representation of the tractor 1 with an attachment embodied as a sowing machine 19 shown from above. When sowing maize or wheat, for example, track markers 20 are used, which can be fastened to the tractor 1. The track marker 20 draws a line 23 into the cropland surface 6 at a specific distance 22 from a track 21, which coincides with the track 16 generated by the tire 13. The operator steering the tractor 1 must drive the next track with a tire 13 on this line 23 in order to maintain the correct distance 22 from the previous track 21. The line 23 recorded by the image-capture device 10 before entrance onto the new track 21 is recognized by the image processing system 8 as a reference object with the aid of the image evaluation. This line 23 is used by a continuous image evaluation as a prespecified track 18 that is to be driven along. The detection of the line 23 generated by the track marker 20 as a reference object for prespecifying the track is suitable for use with an autonomous steering system so that, after passing a headland 24, the track prespecified on the basis of the line 23 can be followed precisely. This relieves the operator from monitoring his keeping to the prespecified track as well as from performing steering operations for correcting deviations from the prespecified track, and he may address other tasks that also require increased attention.

The tracking system described above is used in a comparable manner in the attachment embodied as a plow 3. When plowing, the operator of the tractor 1 must drive with the tire 13 in a furrow 25, which is produced by the plow 3 and which follows the course of the previous track 16. The furrow 25 produced by the plow 3 is recorded by the image-capture device 10 and evaluated by the image processing system 8 as a reference object. The tractor 1 is subsequently guided along the prespecified track 18.

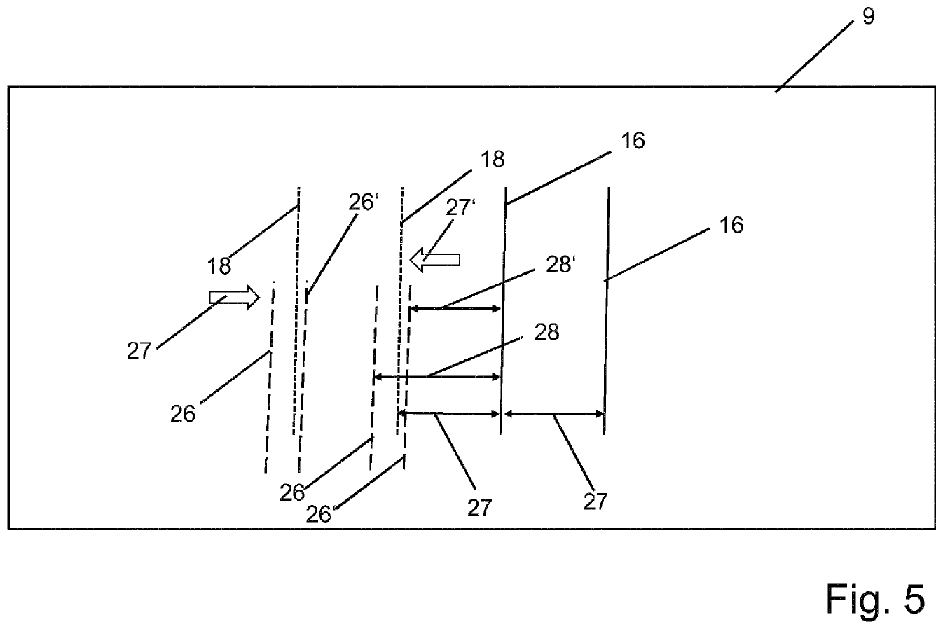

FIG. 5 shows, by way of example, a schematic visualization of the track 16 and a prespecified track 18 on the display device 9, which serves the operator of the tractor 1 as an orientation aid for manual steering. Reference signs 26 designate the actual tracks currently driven, which deviate from the projected prespecified tracks 18. The deviation from the prespecified track 18 is visualized by the overlaying of actual tracks 26, 26′. Arrows 27, 27′ represent an indication of a correction, by which steering movement a correction can be carried out by the operator in order to return to the prespecified track 18. The position and direction of a track deviation 28 can be determined by the image evaluation. For this purpose, a track width 27 of the tractor 1 is defined, which is used as a reference object for comparing the prespecified track and the actual track 26, 26′ in each case. Compliance with the prespecified track 18 can be monitored by evaluating the recorded images of the image-capture device 10 arranged at the rear.

By means of the at least one optical image-capture device 10, reference objects located along a track 18 driven by the tractor 1 are recorded as images. The optically recorded reference objects are differentiated by the image processing system 8 so that the track 18 is prespecified on the basis of an evaluation of the reference objects by the control device 7. The method makes it possible to distinguish between the different reference objects, which are supplied to the control device 7 for evaluation in order to determine distances 15, 22, 27 or track deviations 28, 28′, a deviating contour of the planted rows 17a through 17f and/or the number of rows of the respective reference objects by means of which the new track 18 is prespecified.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Tractor
2 Lifting mechanism
3 Plow
4 Lower links
5 Upper link
6 Cropland
7 Control device
8 Image processing system
9 Display device
10 Image-capture device
11 Actuator
12 Bus system
13 Tires
14a-14f Planted row
15 Row interspace
16 Current track
17a-17f Planted row
18 Prespecified track
18A Entry point
19 Sowing machine
20 Track marker
21 Track
22 Distance
23 Line
24 Headland
25 Furrow
26, 26′ Actual track
27 Correction indication
28, 28′ Track deviation

1. An agricultural work vehicle, comprising:
a track guidance system including:
an optical image-capture device arranged on the work vehicle and being configured to record reference objects located along a track driven by the agricultural work vehicle,
an image processing system configured to differentiate the recorded reference objects, and
a control device configured to evaluate the reference object and prespecify a track based, at least in part, on the evaluation of the reference objects.

2. The agricultural work vehicle according to claim 1, wherein the track guidance system further includes a display device configured to visualize the track prespecified by the control device.

3. The agricultural work vehicle according to claim 2, wherein the display device is further configured to visualize an entry point onto the prespecified track.

4. The agricultural work vehicle according to claim 2, wherein the display device is further configured to visualize deviations of the work vehicle from the prespecified track.

5. The agricultural work vehicle according to claim 1, wherein the control device is configured to perform autonomous steering of the work vehicle based, at least in part, on the prespecified track.

6. The agricultural work vehicle according to claim 1, wherein the track guidance system is configured to recognize and/or count reference objects arranged in rows.

7. The agricultural work vehicle according to claim 1, wherein the track guidance system is set up for defining a distance between a track driven by the work vehicle and a reference line generated during this.

8. The agricultural work vehicle according to claim 1, wherein the control system is further configured to supply a working width of an attachment mounted on the work vehicle.

9. The agricultural work vehicle according to claim 1, wherein the at least one image-capture device is designed as a 3D camera from an angle-offset two-camera system or as a 2D camera with run-time measurement.

10. The agricultural work vehicle according to claim 8, wherein a reference object is a driving lane, a crop edge, a plant row, an auxiliary line, or a furrow produced by the attachment.

11. A method for determining a track of an agricultural work vehicle, the method comprising:
optically recording, by at least one optical image-capture device, reference objects located along a track driven along by a work vehicle;
differentiating the optically recorded reference objects by an image processing system; and
prespecifying the track with the aid of an evaluation of the reference objects performed by a control device.

12. The method according to claim 11, further comprising generating steering signals for autonomously steering the work vehicle by the control device with the aid of the prespecified track.
